(19) United States
(12) Patent Application Publication
(10) Pub. No.: US 2009/0214152 A1
(43) Pub. Date: Aug. 27, 2009

(54) Polarization-maintaining optical coupler and method of making the same

(76) Inventor: Yong Huang, Milpitas, CA (US)

Correspondence Address: Yong Huang, 1079 Sandalwood LN, Milpitas, CA, 95035, US

(21) Appl. No.: 12/290,705

(22) Filed: Nov. 3, 2008

Related U.S. Application Data
(63) Continuation-in-part of application No. 12/075,517, filed on Mar. 11, 2008, now Pat. No. 7,492,977.

(30) Foreign Application Priority Data
Feb. 21, 2008 (CN) 200810043138.4

(51) Int. Cl. G02B 6/00

(52) U.S. Cl. 385/11

(57) ABSTRACT

Embodiments of the present invention provide an optical coupler. The optical coupler includes a fused optical coupling region made of part of a first and a second single-mode (SM) fiber, with a portion of the second SM fiber being a pigtail fiber on a first side of the fused optical coupling region; and a first and a second polarization-maintaining (PM) fiber on the first side and a second side of the fused optical coupling region respectively. Methods of making the optical coupler and system that utilizes the optical coupler are also provided.

### CROSS REFERENCE TO RELATED APPLICATIONS

The present application is a continuation-in-part (CIP) of U.S. patent application Ser. No. 12/075,517, filed Mar. 11, 2008, entitled “All-Fiber Current Sensor”, and claims the benefit of priority of Chinese patent application serial number 200810043138.4, filed Feb. 21, 2008 with the State Intellectual Property Office (SIPO) of the People's Republic of China, the content of which are incorporated herein by reference in their entireties.

### FIELD OF THE INVENTION

The present invention relates to optical couplers and devices that make use thereof. In particular, it relates to polarization-maintaining optical couplers and devices and systems that incorporate and make use of the polarization-maintaining optical couplers.

### BACKGROUND

Optical couplers having properties of maintaining polarization directions of light are widely used in applications such as, for example, devices and/or systems that are designed for measuring and/or sensing electric current. Optical couplers used in electric current sensors are generally made of optical fibers, and up until recently made of polarization-maintaining (PM) fibers. Optical couplers with polarization-maintaining property are referred to, hereinafter, as PM couplers.

As is known in the art, PM fibers rely upon externally induced stresses to maintain polarization directions of light propagating therein. Therefore, performance of PM couplers made of PM fibers are generally sensitive to both temperature and polarization state of input light. This makes these PM couplers not only difficult to make but the manufacturing of these PM couplers demand high degree of diligence and care during assembly in order to achieve certain expected quality, so far the combination of which has lead to low yield in production, poor quality, and certain reliability issues of the final product. Nevertheless, PM couplers, and other similar optical coupling devices, are finding more and more applications in a variety of optical systems, large or small, in addition to electric current sensors.

An electric current sensor, or sensing device, or system that is optical fiber based works in the principle of well-known Faraday Effect. It is generally known that an electric current propagating inside a wire or conductor will induce a magnetic field around the wire or conductor. Now, assume that a light is traveling inside an optical fiber that is wound around a current-carrying wire or conductor. Through Faraday Effect, the magnetic field induced by the current may cause polarization direction of the light to rotate. According to Faraday's law, the degree of rotation will be directly proportional to the magnitude of the magnetic field, thus directly proportional to the magnitude of the electric current carried by the conductor or wire, as well as to the total length of optical path traversed by the light. Therefore, by injecting a light of pre-defined for example linear polarization state into a fiber placed in the sensing region (i.e., magnetic field region) of a wire or conductor and by measuring, and subsequently analyzing, changes in the polarization state of light exiting from the sensing region in the fiber, the amount of electric current carried by the wire or conductor may be determined.

In a fiber-optic based current sensor as described above, the magnitude of rotation of polarization direction of light is usually small. For that reason, a fiber-optic based current sensor usually employs the configuration of a Sagnac interferometer using an optical coupler for improving sensitivity in the detection of polarization direction rotation. However, since a conventional optical coupler made of polarization-maintaining fibers is not capable of properly maintaining polarization directions of light propagating therein, sensors employing conventional optical couplers frequently exhibit unstable device performance due to, at least partially, uncertainty of polarization state of light inside, and have limited value in practice.

In view of the above, there is a need in the art to develop solutions that will address above-mentioned shortcomings of existing fiber-optic based electric current sensors; and in particular, there is an urgent need to develop reliable polarization-maintaining optical couplers with improved yield and generally acceptable device performance.

### SUMMARY OF EMBODIMENTS

Embodiments of the present invention provide an optical coupler. The optical coupler includes a fused optical coupling region made of part of at least a first and a second single-mode (SM) fiber, with a portion of the second SM fiber being a pigtail fiber on a first side of the fused optical coupling region; and a first and a second polarization-maintaining (PM) fiber on the first side and a second side of the fused optical coupling region respectively. In one embodiment, the portion of the second SM fiber has a length of at least 150 mm long.

According to one embodiment, the first PM fiber is spliced to the first SM fiber at a location sufficiently close to, preferably less than 10 mm away from, the first side of the fused optical coupling region, and the second PM fiber is spliced to the second SM fiber at a location sufficiently close to, preferably less than 10 mm away from, the second side of the fused optical coupling region.

According to another embodiment, the first PM fiber is spliced to the first SM fiber at a location sufficiently close to, preferably less than 10 mm away from, the first side of the fused optical coupling region, and the second PM fiber is spliced to the first SM fiber at a location sufficiently close to, preferably less than 10 mm away from, the second side of the fused optical coupling region.

Embodiments of the present invention also provide an optical coupler, which includes a fused optical coupling region made of part of at least a first, a second, and a third single-mode (SM) fiber; a first polarization-maintaining (PM) fiber being spliced to the first SM fiber at a location sufficiently close to a first side of the fused optical coupling region; and a second PM fiber being spliced to the second SM fiber at a location sufficiently close to a second side of the fused optical coupling region, wherein the part of the first, second, and third SM fibers in the fused optical coupling region are arranged either linearly in a row or in a tightly spaced multi-layer, such as two-layer, stack.

According to one embodiment, the optical coupler may include a third PM fiber being spliced to the third SM fiber at a location sufficiently close to the second side of the fused optical coupling region, wherein the first, second, and third PM fibers are spliced to the first, second, and third SM fibers respectively at less than about 10 mm away from the fused optical coupling region.

According to one embodiment, the optical coupler may include a fourth PM fiber being spliced to the first SM fiber at a location sufficiently close to the second side of the fused optical coupling region, thereby being at least a one-by-three optical coupler.

According to one embodiment, the fused optical coupling region may be made of part of the first, second, third SM fibers and at least part of a fourth SM fiber, and the optical coupler, being at least a one-by-four optical coupler, may further include a fifth PM fiber being spliced to the fourth SM fiber at a location sufficiently close to the second side of the fused optical coupling region. According to yet another embodiment, the fused optical coupling region may be made of part of the first, second, third, fourth SM fibers and at least part of a fifth SM fiber, and the optical coupler, being at least a one-by-five optical coupler, may further include a sixth PM fiber being spliced to the fifth SM fiber at a location sufficiently close to the second side of the fused optical coupling region.

Embodiments of the present invention further provide an optical coupler that includes a fused optical coupling region being made of multiple SM fibers; M additional fibers on the first side of the fused optical coupling region; and N additional fibers on the second side of the fused optical coupling region, thereby the optical coupler being a M-by-N optical coupler, wherein the multiple being larger than three (3) and being larger or at least equal to the number M and/or the number N.

Embodiments of the present invention further provide a method of making an optical coupler. The method includes providing a plurality of segment-type fibers, the segment-type fibers having a first segment of polarization-maintaining (PM) fiber and a second segment of single-mode (SM) fiber; arranging the plurality of segment-type fibers in a bundle, the bundle having at least one the first segment of PM fiber and one the second segment of SM fiber at each side of the bundle, and having a common section of tightly spaced the second segment of SM fibers; and fusing and drawing the common section into a fused optical coupling region.

According to one embodiment, providing the plurality of segment-type fibers includes forming the segment-type fibers by splicing together the first segment of PM fiber with the second segment of SM fiber.

According to another embodiment, splicing the first segment of PM fiber to the second segment of SM fiber includes selecting the first segment of PM fiber and the second segment of SM fiber such that a difference between mode-field diameters of the first segment of PM fiber and the second segment of SM fiber is less than about 20%, for a predetermined wavelength range of light.

According to yet another embodiment, arranging the plurality of segment-type fibers includes arranging the second segment of SM fibers of the segment-type fibers in a multi-layer stack.

### BRIEF DESCRIPTION OF THE DRAWINGS

The present invention will be understood and appreciated more fully from the following detailed description of embodiments of the invention, taken in conjunction with the accompanying drawings of which:

FIG. 1 is a simplified illustration of a conventional 3-by-3 polarization-maintaining coupler made of polarization-maintaining fibers as is known in the art;

FIGS. 2a and 2b are demonstrative illustrations of a 3-by-3 polarization-maintaining coupler according to one embodiment of the present invention;

FIGS. 3a and 3b are demonstrative illustrations of segment-type fibers according to some embodiments of the present invention;

FIGS. 4a and 4b are demonstrative illustrations of 3-by-3 polarization-maintaining couplers according to some embodiments of the present invention;

FIGS. 5a and 5b are demonstrative illustrations of 2-by-2 polarization-maintaining couplers according to some other embodiments of the present invention;

FIG. 6 is a demonstrative illustration of a 5-by-5 polarization-maintaining coupler according to yet some other embodiment of the present invention;

FIG. 7 is a simplified flowchart illustration of method of fabricating a polarization-maintaining coupler according to one embodiment of the present invention;

FIG. 8 is a simplified block diagram illustration of an all-fiber electric current sensor applying a 3-by-3 polarization-maintaining coupler according to one embodiment of the present invention; and

FIG. 9 is a simplified block diagram illustration of an all-fiber electric current sensor applying a 3-by-3 polarization-maintaining coupler according to another embodiment of the present invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS

In the following detailed description, numerous specific details are set forth in order to provide a thorough understanding of embodiments of the present invention. However it will be understood by those of ordinary skill in the art that embodiments of the present invention may be practiced without these specific details. In other instances, well-known methods and procedures have not been described in detail so as not to obscure description of embodiments of the invention.

Some portions of the detailed description in the following are presented in terms of algorithms and symbolic representations of operations on electrical and/or electronic signals, and optical signals. These algorithmic descriptions and representations may be the techniques used by those skilled in the electrical and electronic engineering and optical communication arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or electronic or optical signals capable of being stored, transferred, combined, compared, converted, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

In the following description, various figures, diagrams, flowcharts, models, and descriptions are presented as different means to effectively convey the substances and illustrate different embodiments of the invention that are proposed in this application. It shall be understood by those skilled in the art that they are provided merely as exemplary and/or demonstrative samples, and shall not be constructed as limitation to the invention.

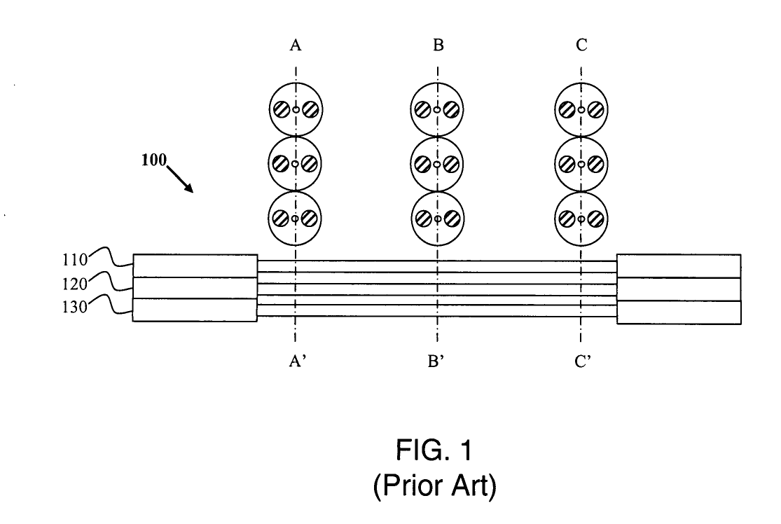

FIG. 1 is a simplified illustration of a conventional 3-by-3 polarization-maintaining coupler made of polarization-maintaining fibers as is known in the art. In making 3-by-3 PM coupler 100, generally three traditional PM fibers 110, 120, and 130 are first linearly aligned, in a closely spaced fashion one next to the other, as being illustrated in cross-sections A-A′, B-B′, and C-C′ of FIG. 1. Next, a section of the three closely spaced PM fibers 110, 120, and 130, at around cross-section B-B′ in the middle, is fused and drawn into an optical coupling region as is known in the art, thus forming 3-by-3 PM coupler 100.

Here, a person skilled in the art shall appreciate that FIG. 1 as well as other drawings throughout this application are for illustration purpose only. For example, spaces or small gaps in between fibers shown in the drawings are only for better illustration of each individual fiber. The fibers are actually closely spaced to be in contact at the side surface one next to the other, as being illustrated at the cross-sections of various locations. In addition, the cross-sections are shown before the optical fibers is fused and drawn into an optical coupling region. The process of fusing and drawing will in general produce a cross-section that is slightly different from that of cross-section B-B′, for example, with generally closer distance between the fiber cores, and a single common fused cladding covering all the fiber cores, as is well know in the art.

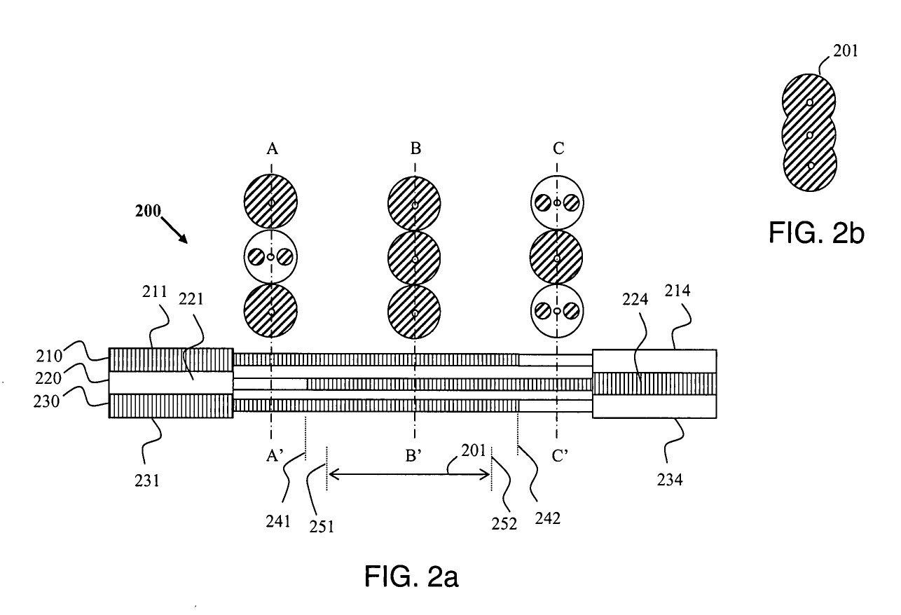

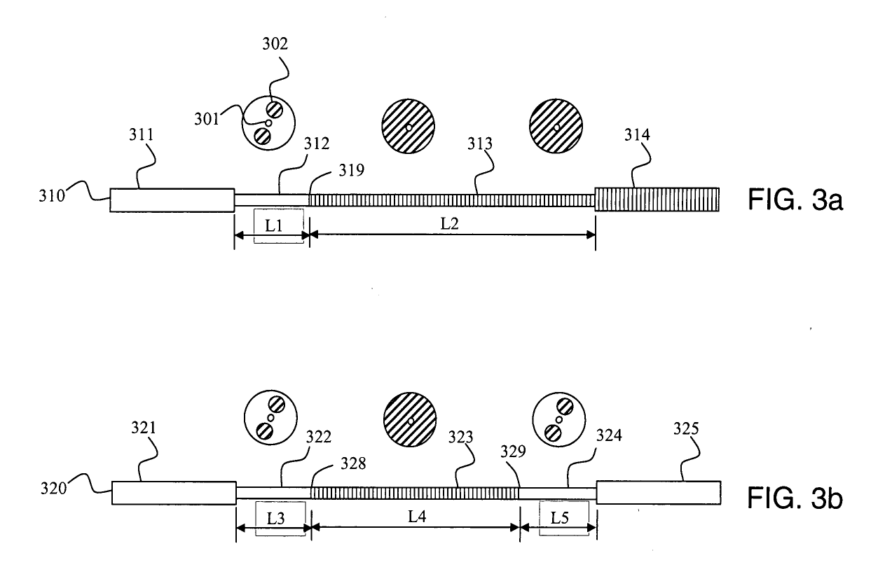

FIGS. 2a and 2b are demonstrative illustrations of a 3-by-3 polarization-maintaining coupler according to one embodiment of the present invention. PM coupler 200 may be made of three segment-type (ST) fibers 210, 220, and 230, which may be made of segments of single-mode fiber and polarization-maintaining fiber according to some embodiments of the present invention as described below in detail with reference to FIGS. 3a and 3b. In addition, PM coupler 200 may be a 3-by-3 PM coupler and have an optical coupling region made through fusing and drawing a middle section 201 of conventional single-mode (SM) fibers of the three segment-type fibers. The fused coupling region may have a cross-section area as illustrated in FIG. 2b, wherein the three fiber cores are spaced closer than they are, as being illustrated at cross-section B-B′ of FIG. 2a before the fusing and drawing process, with a common fused cladding covering all three fiber cores.

Here, it is worth noting that the term N-by-M PM coupler means that the PM coupler has maximum N input/output ports on one side and M input/output ports on the other side. In practice, the PM coupler may be used for any number of input and/or output ports as desired, for example as an N-by-1 PM coupler, a 1-by-M PM coupler, or a 2-by-3 PM coupler, up to the maximum available ports on each side. Ports that are not used may be properly terminated or may have been designed to have little coupling effect.

Reference is briefly made to FIGS. 3a and 3b, which are demonstrative illustrations of segment-type (ST) fibers according to some embodiments of the present invention. For example, segment-type fiber 310 may be made of a first segment (piece) of polarization-maintaining fiber (including sections 311 and 312) and a second segment (piece) of single-mode fiber (including sections 313 and 314), the two of which are fusion-spliced together at a point 319. In FIG. 3a, section 312 (of length L1) of PM fiber is illustrated to be slightly thinner than section 311 to show that covering jacket and possible buffer layers of the PM fiber may be removed for splicing purpose. Otherwise, sections 311 and 312 are a same piece of PM fiber. Similarly, section 313 (of length L2) of SM fiber is drawn to be slightly thinner than section 314 to illustrate that covering jacket and possible buffer layers of the SM fiber may be removed for splicing purpose and otherwise sections 313 and 314 are a same piece of SM fiber.

Similarly, fiber 320 of a three-segment type may be made of a first segment or piece of polarization-maintaining fiber (including sections 321 and 322 of length L3), a second segment or piece of single-mode fiber 323 of length L4, and a third segment or piece of polarization-maintaining fiber (including sections 324 of length L5 and 325). As being demonstratively illustrated in FIG. 3b, the first segment of PM fiber is fusion-spliced with the second segment of SM fiber at a point 328, and the second segment of SM fiber is fusion-spliced, at the other end, with the third segment of PM fiber at a point 329.

As is illustrated in the cross-section of FIG. 3a, PM fiber 312 has a core 301, and usually two stress rods 302 which induce birefringence into core 301 of fiber 312. Generally, birefringence in a PM fiber creates two orthogonal polarization directions or axes, one fast and one slow, for light-wave propagating therein, thus provides polarization-maintaining property as is well known in the art. Examples of polarization-maintaining fibers may include, for example, 1550 nm Panda fiber or any other suitable current or future available PM fibers. Examples of single-mode fibers may include, for example, Corning SMF28 fiber, Corning HI1060Flex fiber, OFS980 fiber, Chang Fei G652 fiber, and/or any other suitable current or future available SM fibers.

Embodiments of the present invention also provide a method for preparing segment-type fibers such as ST fiber 310 and/or 320. According to one embodiment, the method may include providing a piece of PM fiber (e.g., 311 and 312) of a length of, for example, at least 150 mm long and removing the covering jacket of segment 312 in a length L1 of, for example, from around 2 mm to around 15 mm and preferably around 5 mm to 10 mm. Next, a relatively smooth and substantially perpendicular end of PM fiber 312 may be prepared, for splicing purpose, by a blade or a cleaver or any other suitable means as is known now or being developed in future. Embodiment of the method may also include providing a piece of SM fiber (e.g., 313 and 314) of a length of, for example, at least 150 mm or 200 mm long and removing the covering jacket of segment 313 in a length L2 of, for example, from around 13 mm to around 55 mm and preferably around 20 mm to 25 mm. Here, a person skilled in the art will appreciate that length L1 and length L2 may be longer or shorter than those suggested above. In principle, length L2 of SM fiber 313 shall be sufficiently long so that it may be drawn into an optical coupling region later, while length L1 of PM fiber 312 shall be sufficient short (in order to make devices made of ST fiber 310 compact, as described below) but long enough such that it may be spliced to SM fiber 313 without difficulty. Generally, in order to reduce coupling loss from PM fiber 312 to SM fiber 313, or vise versus, fibers 312 and 313 shall be selected to have approximately same or close mode-field diameters. For example, according to one embodiment, a difference less than 20% in mode-field diameter between fibers 312 and 313 is preferred in order to achieve certain nominally acceptable coupling loss. Difference in mode-field diameter may be over a pre-determined wavelength range of, for example, 1510 nm to 1560 nm or 950 nm to 1600 nm, larger or smaller depending on the actual application of the PM coupler. According to another embodiment, fibers with mode-field diameter difference larger than 20% may be used as well depending on actual application needs or system loss requirement. Next, embodiment of the method includes fusion-splicing PM fiber 312 with SM fiber 313 at point 319 to make ST fiber 310.

Similarly, ST fiber 320 shown in FIG. 3b may be made by fusion-splicing PM fiber 322 to SM fiber 323 with a length of L3 being approximately the same as L1 and a length of L4 being approximately the same as L2, and then by splicing SM fiber 323 with PM fiber 324 with a length of L5 being approximately the same as L3.

Reference is made back to FIG. 2a. Segment-type (ST) fibers 210, 220, and 230 may be arranged to be next to each other linearly, and in contact with each other on side surface, in a common plane to form a fiber bundle, as is shown in cross-section A-A′, B-B′, and C-C′ at different locations. At least at one end of the fiber bundle there is at least one PM fiber segment of the ST fibers. For example, there is PM fiber segment 221 at the left side end and there are PM fiber segments 214 and 234 at the right side end of the fiber bundle. The three segment-type fibers meet in a common region 201, where they are all made of SM fibers.

The common region 201 of single-mode fibers are then drawn into an optical coupling region through, for example, a technique commonly known as fusion-drawing. According to one embodiment of the present invention, the optical coupling region may be made sufficient close to the connection points (splicing points) between PM fiber and SM fiber. For example, connection point 241 may be made sufficiently close to end point 251 of common region (or coupling region) 201, less than 20 mm and preferably less than 10 mm. Similarly connection point 242 may be arranged to be close enough to end point 252 of common region (or coupling region) 201, less than 20 mm and preferably less than 10 mm. Generally, the closer the splicing or connection point to the coupling region, the more stable the performance of coupler will be. However, certain tradeoff may be made between coupler performance and the ease of manufacturing since the closer the splicing point to the coupling region, in some instances strength of the splicing may be compromised.

PM coupler 200 may work like the following. An optical signal may be launched into, for example, PM fiber 221 and may propagate to SM fiber 224 that may be directly connected to PM fiber 221. The optical signal may also be coupled to PM fiber 214 and/or 234 via optical coupling region 201. Alternatively, an optical signal launched into, for example, SM fiber 224 may propagate to PM fiber 221, or be coupled to SM fiber 211 and/or 231 via optical coupling region 201. The amount of power propagating to a directly connected fiber or being coupled to a closely placed neighboring fiber may depend upon the length of coupling region 201, and how tightly the three SM fibers are fused together.

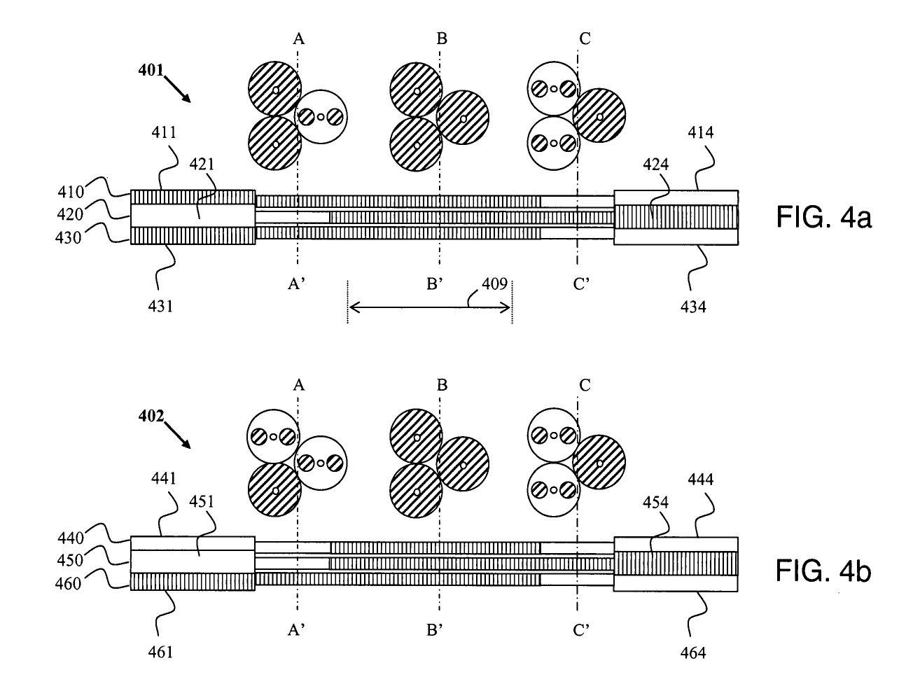

FIGS. 4a and 4b are demonstrative illustrations of 3-by-3 polarization-maintaining couplers according to some embodiments of the present invention. PM coupler 401 may be made of fibers 410, 420, and 430 that are segment-type (ST) fibers, that is, at least one segment of PM fiber and one segment of SM fiber as described above. Fibers 410, 420, and 430 may have a common optical coupling region 409 made of fused single-mode fibers which are part of ST fibers 410, 420, and 430. Comparing with PM coupler 200 in FIG. 2, ST fibers 410, 420, and 430 in PM coupler 401 may be arranged in a stacked fashion, at least in the fused optical coupling region 409. For example, instead of being placed and aligned in a common plane as in FIG. 2, one ST fiber 420 may be laid on top of other two ST fibers 410 and 430, in a tightly close fashion. According to one embodiment, PM fiber segments of ST fibers 410, 420, and 430 may be arranged in such a way that their fast and slow polarization axes are oriented in substantially the same direction. For example, fast axes of polarization direction may be oriented in the direction of optical coupling or orthogonal to the optical coupling direction. However, a person skilled in the art will appreciate that present invention may not be limited in this respect. For example, depending on actual optical coupling needs, direction of polarization axes of the PM fibers may be arranged in different orientations, and in some instance slow polarization axes of one or more PM fibers may be oriented with fast polarization axes of one or more other PM fibers.

According to one embodiment of the present invention, single-mode fiber segment of one ST fiber may be different from single-mode fiber segment of another ST fiber, in terms of core size, cut-off wavelength, and/or dispersion or dispersion slope, etc. When ST fibers with different single-mode fibers are used in making a PM coupler through their fused optical coupling region of single-mode fibers, different and preferable optical coupling properties may be obtained. For example, PM couplers with wide coupling bandwidth may be obtained through this approach, which may be suitable for accommodating broadband optical signals; optical signals of multiple wavelengths; and in certain applications, WDM (wavelength-division-multiplexing) signals.

Since single-mode fibers are used in forming the fused optical coupling region, PM coupler 401, and other PM couplers made in accordance with embodiments of the present invention, may have the advantages of a regular single-mode optical coupler such as low polarization dependent loss (PDL) and low temperature sensitivity of polarization extinction ratio. On the other hand, PM couplers made in accordance with embodiments of the present invention provide the performance of maintaining polarization directions of input and output lights, but without the reliability and/or stability issues that are often encountered in optical couplers made of traditional polarization-maintaining fibers. In FIG. 4b, PM coupler 402 may be made of one three-segment ST fiber 440 (including 441 and 444) and two two-segment ST fibers 450 (including 451 and 454) and 460 (including 461 and 464). ST fibers 440, 450, and 460 are fused together in their SM fiber sections which form an optical coupling region among the ST fibers.

A person skilled in the art will also appreciate that the above 3-by-3 PM coupler may be used, depending on actual requirement for the number of input and output ports, as 1-by-2, 1-by-3, 2-by-2, or 2-by-3 optical couplers by selecting the desired number of input and output ports of either PM or SM fibers. The above 3-by-3 PM coupler may also be used as a regular optical coupler in situations wherein maintaining polarization directions of input and/or output light may not be essential or necessary.

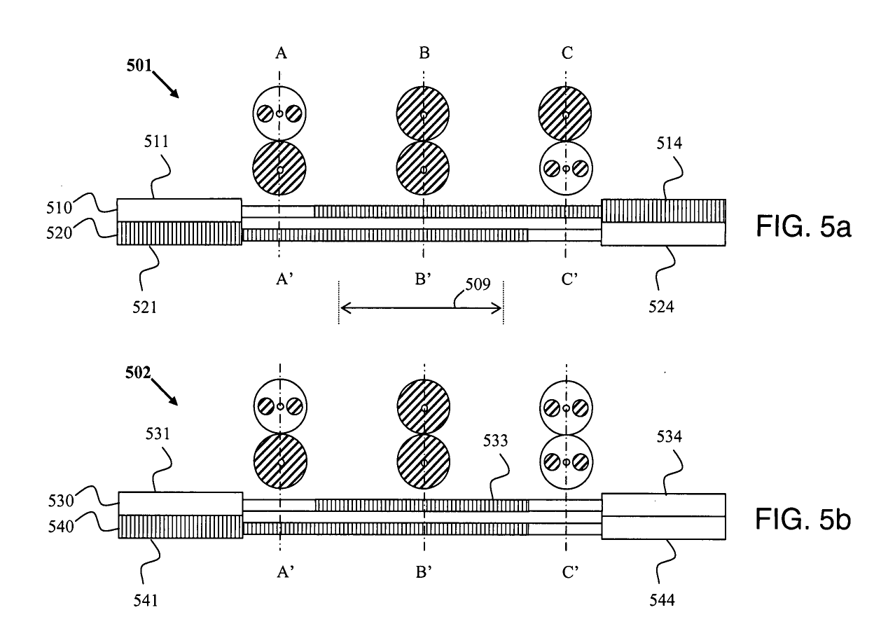

FIGS. 5a and 5b are demonstrative illustrations of 2-by-2 polarization-maintaining couplers according to some other embodiments of the present invention. PM coupler 501 may be made of two ST fibers 510 and 520 arranged in such a way that they have a common fused coupling region made of single-mode fibers, and each side of PM coupler 501 has one PM fiber and one SM fiber. PM coupler 502 may be made of two ST fibers 530 and 540, one of which may be a three-segment ST fiber 530 and the other a two-segment ST fiber 540. It shall be noted that embodiments of the present invention may not be limited to either 2-by-2 or 3-by-3 PM couplers or method of making the same. For example, embodiments of the present invention may be applied in making M-by-N optical couplers where M and N may be any suitable integer numbers such as, for example, 2, 3, 4, and 5.

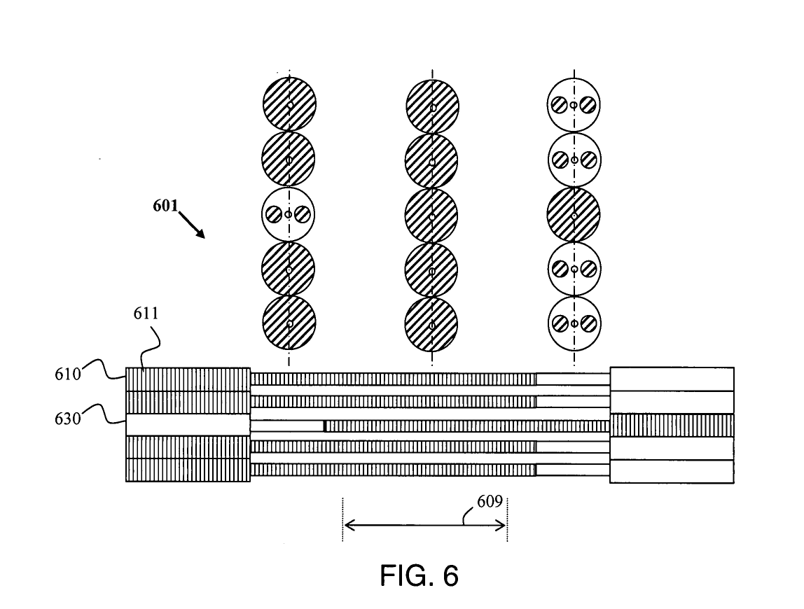

For example, FIG. 6 is a demonstrative illustration of a 5-by-5 polarization-maintaining coupler according to yet some other embodiment of the present invention. In FIG. 6, PM coupler 601 has five ST fibers, such as ST fibers 610 and 630, arranged in a linear fashion. Furthermore, it is to be appreciated that PM couplers according to embodiments of the present invention may be made of a combination of ST fibers and regular SM fibers. For example, a 5-by-5 PM coupler may be made of two ST fibers and three regular SM fibers (not shown), with each side of the coupler has at least one segment of PM fiber.

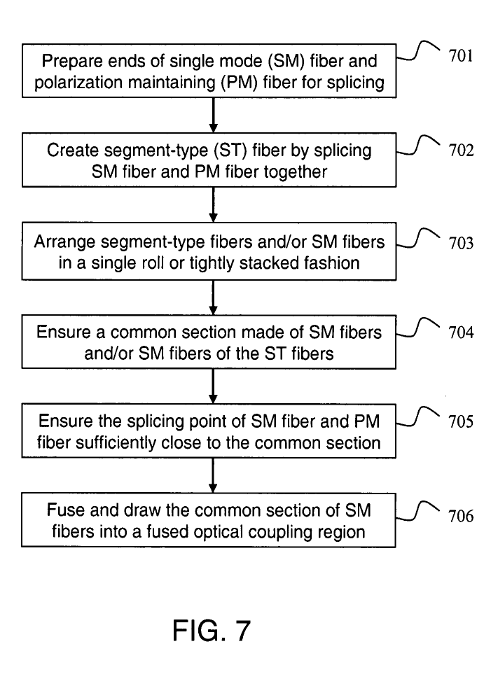

FIG. 7 is a simplified flowchart illustration of method of fabricating a polarization-maintaining coupler according to one embodiment of the present invention. More specifically, one embodiment of the method may include steps of preparing ends of single mode fibers and polarization maintaining fibers for splicing (701), and making fibers of segment-type (702) by, for example, fusion-splicing together pigtails of single-mode fibers with polarization-maintaining fibers. With the segment-type fibers, one embodiment of the method may include arranging the pre-prepared segment-type fibers in a bundle, either in a single role or in a tightly stacked multi-layer fashion (703). The arrangement has, at each side of the fiber bundle, at least one single-mode fiber pigtail and at-least one polarization-maintaining fiber pigtail. According to one embodiment, the method ensures that the fiber bundle has a middle section of single-mode fibers from SM fiber segment of the ST fibers (704). Embodiment of the method also ensures that the splicing point of SM fiber and PM fiber is arranged to be sufficiently close to the middle section of SM fibers (705). Furthermore, the method may include steps of fusing and drawing the middle section of SM fibers into an optical coupling region (706) thus forming a PM coupler.

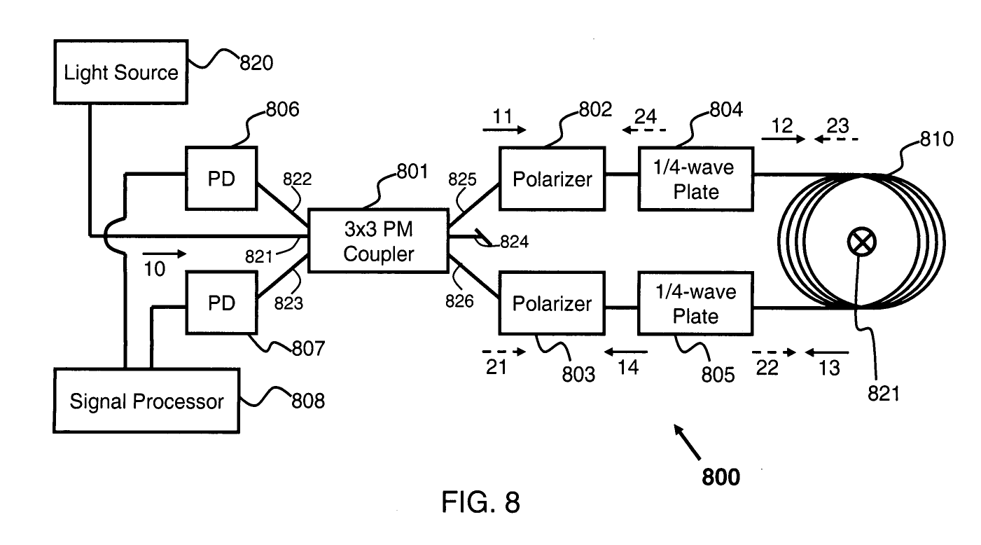

FIG. 8 is a simplified block diagram illustration of an all-fiber electric current sensor applying a 3-by-3 polarization-maintaining coupler according to one embodiment of the present invention. Electric current sensor 800 may include a PM coupler 801, which may be made in accordance with embodiments of the present invention as described above, and therefore may be able to maintain polarization state of light propagating therein. Additionally, PM coupler 801 may be designed to cause a phase difference of substantially close to 0 or 120 degrees of light coming from certain input and/or output ports. For example, PM coupler 801 may have a first set of ports 821, 822, and 823 on one side (first side) and a second set of ports 824, 825, and 826 on the other side (second side). Being a bidirectional device, PM coupler 801 may work either as a coupler or a splitter. Ports 821-826 may function or be used as input and/or output ports. According to one embodiment, PM coupler 801 may be made of three ST fibers fused in a middle section of single-mode fibers, such as PM coupler 200 as being illustrated in FIG. 2. Ports 821, 825, and 826 may correspond to PM fiber segment of 221, 214, and 234, and ports 822, 823, and 824 may correspond to SM fiber segment of 211, 231, and 224.

One or more optical signals launched into one or more ports of one side of PM coupler 801 may be coupled, through propagating inside thereof having polarization states being properly maintained, to one or more ports of the other side of PM coupler 801. For example, a polarized optical input or optical signal launched into port 821 of the first side may be coupled to ports 824, 825 and/or 826 of the second side of PM coupler 801. More specifically, according to one embodiment, an optical signal or light launched into port 821 may be coupled to ports 825 and 826 in substantially equal amount and phase, which may have a phase difference of close to, or substantially close to, 120 degrees from that of port 821. In another embodiment, optical signals or lights coupled into ports 825 and 826 from port 821 may be in substantially equal amount but with a phase difference close to, or substantially close to, 120 degrees with each other and with that of port 821. In yet another embodiment, optical signals or lights coupled to ports 825 and 826 may be in different amounts and with a phase difference close to, or substantially close to, either 120 degrees or 0 degree, which in turn may have a phase difference of close to, or substantially close to, 120 degrees from that of port 821.

In an opposite direction to that described above, polarized optical inputs or optical signals launched into ports 825 and 826 of the second side may be coupled to ports 821, 822 and/or 823 of the first side with their respective polarization states and relative phase relationship among the ports, as described above, being properly maintained.

According to one embodiment, end of fiber at port 824 of second side may be treated with an anti-reflection coating material and/or may be cut in an angle, such that back-reflections of light or optical signal from the end of the fiber may be substantially reduced, and/or preferably eliminated.

Electric current sensor 800 may also include a light source 820, being connected to port 821 of the first side of PM coupler 801; first and second photon-detectors 806 and 807, being connected respectively to ports 822 and 823 of the same side; and a signal processor 808, being connected to both first and second photon-detectors 806 and 807. Electric current sensor 800 may further include first and second polarizers 802 and 803, being connected respectively to ports 825 and 826 of the second side of PM coupler 801; first and second quarter-wave plates 804 and 805, being connected respectively to first and second polarizers 802 and 803; and a current sensing fiber coil 810 that has two terminals (ends) being connected respectively to first and second quarter-wave plates 804 and 805. Connections between PM coupler 801, polarizers 802 and 803, quarter-wave plates 804 and 805, fiber coil 810, and photon-detectors 806 and 807 may be through their respective pigtail fibers, and may be made through, for example, fusion splicing, optical connectors, and/or other currently available or future developed techniques.

It shall be noted that configuration of electric current sensor or current sensing device 800, according to embodiments of the present invention, may not be limited in those aspects as being demonstratively illustrated in FIG. 8 and various deviations and/or variations from the configuration in FIG. 8 may be considered as within the essence and spirit of the present invention. For example, first and second polarizers 802 and 803 may be connected in places other than between PM coupler 801 and quarter-wave plate 804 or quarter-wave plate 805. In one embodiment, first and second polarizers 802 and 803 may be connected between photon-detector 806 (or photon-detector 807) and PM coupler 801, via port 822 (or port 823) at the first side of PM coupler 801. Also for example, a polarizer (not shown) may be connected between light source 820 and port 821 for controlling polarization state of light being launched into port 821 of PM coupler 801. Further for example, an optical isolator (not shown) may be used between light source 820 and port 821 for reducing or preferably eliminating light travelling potentially backward from PM coupler 801 toward light source 820 which in certain instances may cause instability of operation of light source 820.

During operation, light source 820 may launch an optical signal into port 821 of PM coupler 801. The optical signal may preferably be a linearly polarized, e.g., x-direction (perpendicular to this paper) polarized light 10. However, the present invention is not limited in this respect and other polarized or non-polarized light may be used as well. In one embodiment, a non-polarized light may become linearly polarized after passing through a polarizer (not shown) inserted between light source 820 and port 821 of PM coupler 801. Light 10 may subsequently split, inside PM coupler 801 which functions as a splitter in this instance, into two lights 11 and 21 of both x-direction polarized and lights 11 and 21 may propagate toward polarizers 802 and 803, via ports 825 and 826, respectively. In one embodiment, lights 11 and 21 may have substantially same phases. In another embodiment, lights 11 and 21 may have a phase difference substantially close to 120 degrees.

Polarizer 802 may align linearly polarized light 11, or convert a non-polarized light into linearly polarized light 11, with a direction, with respect to quarter-wave plate 804, such that after propagating through quarter-wave plate 804 linearly polarized light 11 becomes a right circularly polarized light 12. For example, polarization direction of light 11 may be aligned 45 degree relative to the main polarization axis or polarization direction of quarter-wave plate 804. Similarly, polarizer 803 may align linearly polarized light 21, or convert a non-polarized light into linearly polarized light 21, with a direction, with respect to quarter-wave plate 805, such that after propagating through quarter-wave plate 805 linearly polarized light 21 becomes a left circularly polarized light 22. For example, polarization direction of light 21 may be aligned −45 degree relative to the main polarization axis or polarization direction of quarter-wave plate 805.

Fiber coil 810 used for sensing electric current may be spun around a medium such as a conductor or wire 821 that carries an electric current under measurement, detection, or test. Electric current carried by and flowing inside conductor 821 may create a magnetic field along the optical path of fiber coil 810, causing rotation of polarization direction of lights propagating therein, which is known in the art as Faraday Effect. More specifically, right circularly polarized light 12, after propagating through fiber coil 810, may experience a first phase shift to become a right circularly polarized light 13. Right circularly polarized light 13 may then be converted, by quarter-wave plate 805, back into an x-direction linearly polarized light 14 carrying a first phase information which is directly related to the magnitude of current inside conductor 821.

Similarly, left circularly polarized light 22, after propagating through fiber coil 810 in a direction opposite to that of light 12, may experience a second phase shift to become a left circularly polarized light 23. The second phase shift may be different from the first phase shift. Left circularly polarized light 23 may then be converted, by quarter-wave plate 804, back into an x-direction linearly polarized light 24 carrying a second phase information which is also related to the magnitude of current inside conductor 821.

Linearly polarized lights 14 and 24 may subsequently be launched into PM coupler 801, via ports 826 and 825 respectively. Since phase differences among different ports of PM coupler 801 are substantially close to 120 degrees, as compared with 90 degrees of a conventional 2×2 optical coupler, PM coupler 801 may create coherent interference between linearly polarized lights 14 and 24 without the need for additional phase shift elements or devices as required in a conventional fiber-based electric current sensor. Coming out of PM coupler 801, a combination of lights 14 and 24 may then propagate along ports 822/823 to photon-detectors 806/807, wherein it is converted into a photocurrent. Electrical outputs of photon-detectors 806/807 are connected to signal processor 808, which receives photocurrents from photon-detectors 806 and 807, processes information carried by the photocurrents, and determines the amount of current carried inside by conductor 821.

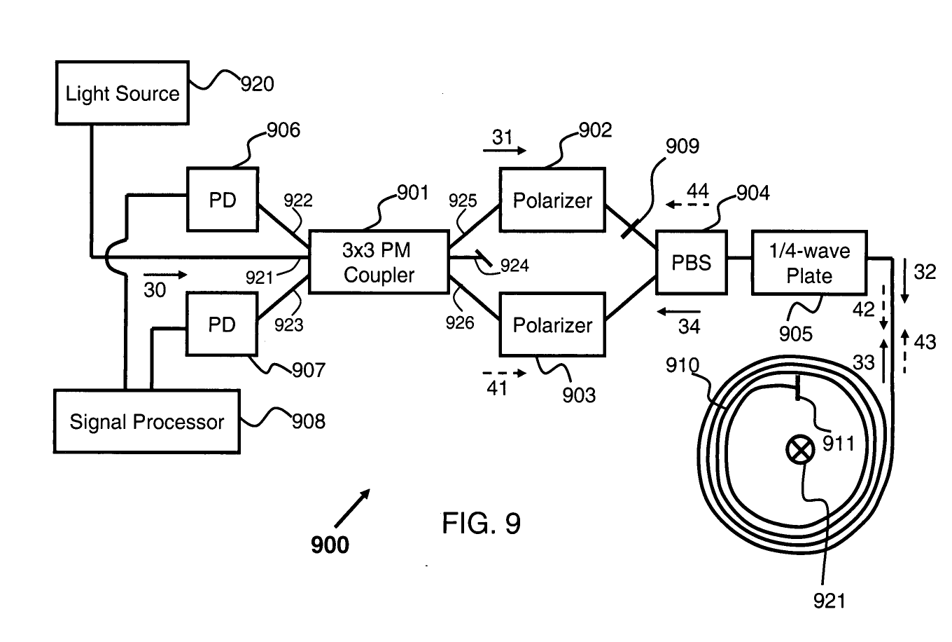

FIG. 9 is a simplified block diagram illustration of an all-fiber electric current sensor applying a 3-by-3 polarization-maintaining coupler according to another embodiment of the present invention. Electric current sensor or current sensing device 900 may include a 3-by-3 PM coupler 901, and has a first set of ports 921, 922, and 923 on a first side and a second set of ports 924, 925, and 926 on a second side. PM coupler 901 is a bi-directional device working either as a splitter or a coupler, and ports 921-926 may be used as input and/or output ports. PM coupler 901 may be substantially the same as PM coupler 801 in FIG. 8.

Electric current sensor 900 may include a light source 920, being connected to port 921 of the first side of PM coupler 901; first and second photon-detectors 906 and 907, being connected respectively to ports 922 and 923 of the same side; and a signal processor 908, being connected to electrical outputs of first and second photon-detectors 906 and 907. Electric current sensor 900 may also include first and second polarizers 902 and 903, being connected respectively to ports 925 and 926 of the second side of PM coupler 901; a polarization beam splitter (PBS) 904 connected to both first and second polarizers 902 and 903; a quarter-wave plate 905 connected PBS 904; and a current sensing fiber coil 910. Fiber coil 910 used for electric current sensing has one end connected to quarter-wave plate 905, and another end being properly terminated with a high-reflection coating material or a mirror such that optical signals propagating towards the end may be substantially reflected back into the fiber coil 910.

It shall be noted that configuration of current sensing device 900 of present invention is not limited in aspects demonstratively illustrated in FIG. 9, and various deviations and/or variations from the configuration in FIG. 9 may be considered as within the essence and spirit of present invention. For example, first and second polarizers 902 and 903 may be connected or placed in places other than between PM coupler 901 and PBS 904. According to one embodiment, first and second polarizers 902 and 903 may be connected or inserted between photon-detectors 906 and 907 and PM coupler 901, via ports 922 and 923 at the first side.

According to one embodiment of the present invention, connection between polarizer 902 and one input/output branch of PBS 904 may be made through a 90-degree rotation of polarization axis of their respective pigtail fibers. In other words, a polarization axis of pigtail fiber of polarizer 902 may be made 90 degree, at connection point 909, relative to that of pigtail fiber of PBS 904 such that, for example, an x-direction linearly polarized light coming from polarizer 902 may be launched into PBS 904 as a y-direction linearly polarized light.

During operation, light source 920 may launch an optical signal into port 921 of PM coupler 901. The optical signal may be a linearly polarized light, e.g., an x-direction polarized light 30. However, the present invention is not limited in this respect and other polarized or non-polarized light may be used as well. Light 30 may subsequently split inside PM coupler 901, which functions as a splitter, into two lights 31 and 41 of both x-direction linearly polarized propagating along ports 925 and 926 respectively. Polarizer 902 connected to port 925 may ensure that light 31 from port 925 is x-direction linearly polarized. Similarly, polarizer 903 may ensure that light 41 from port 926 is x-direction linearly polarized.

At point 909, light 31 from port 925 is rotated 90-degree or substantially close to 90-degree to become a y-direction linearly polarized light and is launched into a first branch of PBS 904. On the other hand, light 41 from port 926 remains as an x-direction linearly polarized light and is launched into a second branch of PBS 904 without polarization rotation or with a substantially close to 0-degree polarization rotation. PBS 904 may combine two mutually orthogonal linearly polarized lights and couple them into quarter-wave plate 905. More specifically, PBS 904 may couple x-direction linearly polarized light 41 and y-direction linearly polarized light 31 into quarter-wave plate 905.

PBS 904 may be connected through its pigtail fiber to quarter-wave plate 905 in such a way that quarter-wave plate 905 may convert a y-direction linearly polarized light, e.g. light 31, into a left circularly polarized light 32, and convert an x-direction linearly polarized, e.g. light 41, into a right circularly polarized light 42. Left and right circularly polarized lights 32 and 42 may propagate along fiber coil 910 respectively, and may experience different amount of rotations of their polarization states. The amount of rotation may be proportional to the current inside conductor 921 but in different magnitude.

Upon reaching the other end or terminal 911 of fiber coil 910, left circularly polarized light 32 may be reflected back by terminal 911 as light 33 to travel in opposite direction back toward quarter-wave plate 905. Right circularly polarized light 42 may be reflected back by terminal 911 as light 43 to travel toward quarter-wave plate 905 as well. Quarter-wave plate 905 may convert light 33 into an x-direction linearly polarized light 34, and convert light 43 into a y-direction linearly polarized light 44.

PBS 904 may direct x-direction linearly polarized light 34 to port 926, via polarizer 903, and y-direction linearly polarized light 44 to port 325, via polarizer 302. In directing y-direction linearly polarized light 44, light 44 is first converted into an x-direction linearly polarized light, through the 90-degree rotation of polarization axis of polarization-maintaining fiber at point 909, and then the x-direction linearly polarized light is launched into port 925.

Linearly polarized lights 34 and 44, which may carry different phase information resulting from the rotation of polarization direction caused by current inside conductor 921, may be launched into 3-by-3 PM coupler 901. Since phase differences among different ports of PM coupler 901 are substantially close to 120 degrees, as compared with 90 degrees of a conventional 2×2 optical coupler, PM coupler 901 may create coherent interference between input lights 34 and 44. The interference may subsequently be detected by photon-detectors 906 and/or 907 via ports 922 and 923. Signal processor 908 may then receive photocurrents produced by photon-detectors 906 and/or 907, process the information carried by the photocurrents, and determine the amount of current carried by conductor 921.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the spirit of the invention.

What is claimed is:

1. An optical coupler, comprising:
a fused optical coupling region made of part of at least a first and a second single-mode (SM) fiber, with a portion of said second SM fiber being a pigtail fiber on a first side of said fused optical coupling region; and
a first and a second polarization-maintaining (PM) fiber on said first side and a second side of said fused optical coupling region respectively.

2. The optical coupler of claim 1, wherein said first PM fiber is spliced to said first SM fiber at a location sufficiently close to said first side of said fused optical coupling region, and said second PM fiber is spliced to said second SM fiber at a location sufficiently close to said second side of said fused optical coupling region.

3. The optical coupler of claim 1, wherein said first PM fiber is spliced to said first SM fiber at a location sufficiently close to said first side of said fused optical coupling region, and said second PM fiber is spliced to said first SM fiber at a location sufficiently close to said second side of said fused optical coupling region.

4. The optical coupler of claim 1, wherein said first PM fiber is spliced to said first SM fiber at less than about 10 mm away from said first side of said fused optical coupling region, and said second PM fiber is spliced to said second SM fiber at less than about 10 mm away from said second side of said fused optical coupling region.

5. The optical coupler of claim 1, wherein said first PM fiber is spliced to said first SM fiber at less than about 10 mm away from said first side of said fused optical coupling region, and said second PM fiber is spliced to said first SM fiber at less than about 10 mm away from said second side of said fused optical coupling region.

6. The optical coupler of claim 1, wherein said portion of said second SM fiber has a length of at least 150 mm long.

7. An optical coupler, comprising:
a fused optical coupling region being made of part of at least a first, a second, and a third single-mode (SM) fiber;
a first polarization-maintaining (PM) fiber being spliced to said first SM fiber at a location sufficiently close to a first side of said fused optical coupling region; and
at least a second PM fiber being spliced to said second SM fiber at a location sufficiently close to a second side of said fused optical coupling region.

8. The optical coupler of claim 7, wherein said part of said first, second, and third SM fibers in said fused optical coupling region are arranged either linearly in a row or in a tightly spaced two-layer stack.

9. The optical coupler of claim 7, further comprising a third PM fiber being spliced to said third SM fiber at a location sufficiently close to said second side of said fused optical coupling region, wherein said first, second, and third PM fibers are spliced to said first, second, and third SM fibers, respectively, at less than about 10 mm away from said fused optical coupling region.

10. The optical coupler of claim 9, further comprising a fourth PM fiber being spliced to said first SM fiber at a location sufficiently close to said second side of said fused optical coupling region, thereby said optical coupler being at least a one-by-three optical coupler.

11. The optical coupler of claim 10, wherein said fused optical coupling region being made of said part of said first, second, third SM fibers and part of a fourth SM fiber, further comprising a fifth PM fiber being spliced to said fourth SM fiber at a location sufficiently close to said second side of said fused optical coupling region, thereby said optical coupler being at least a one-by-four optical coupler.

12. The optical coupler of claim 11, wherein said fused optical coupling region being made of said part of said first, second, third, fourth SM fibers and part of a fifth SM fiber, further comprising a sixth PM fiber being spliced to said fifth SM fiber at a location sufficiently close to said second side of said fused optical coupling region, thereby said optical coupler being at least a one-by-five optical coupler.

13. The optical coupler of claim 7, wherein said fused optical coupling region being made of a plurality of SM fibers, further comprising M additional fibers on said first side of said fused optical coupling region, and N additional fibers on said second side of said fused optical coupling region, thereby said optical coupler being a M-by-N optical coupler, wherein said M and said N being integers larger than three, and said plurality being larger than three and being at least equal to said M or said N.

14. The optical coupler of claim 13, wherein said M and N additional fibers are selected from a group consisting of SM fiber, PM fiber and any combination thereof, and said plurality of SM fibers are selected from a group consisting of Corning SMF28 fiber, Corning HI1060Flex fiber, OFS980 fiber, Chang Fei G652 fiber, and any combination thereof.

15. A method of making an optical coupler, comprising:
providing a plurality of segment-type fibers, said segment-type fibers having at least a first segment of polarization-maintaining (PM) fiber and a second segment of single-mode (SM) fiber;
arranging said plurality of segment-type fibers in a bundle, said bundle having at least one said first segment of PM fiber and one said second segment of SM fiber at each side of said bundle, and having a common section of tightly spaced said second segment of SM fibers; and
fusing and drawing said common section into a fused optical coupling region.

16. The method of claim 15, wherein providing said plurality of segment-type fibers comprises creating said segment-type fibers by splicing said first segment of PM fiber to said second segment of SM fiber.

17. The method of claim 16, wherein splicing said first segment of PM fiber to said second segment of SM fiber comprises selecting said first segment of PM fiber and said second segment of SM fiber such that a difference between mode-field diameters of said first segment of PM fiber and said second segment of SM fiber is less than about 20% for a predetermined wavelength range of light.

18. The method of claim 15, wherein arranging said plurality of segment-type fibers comprises arranging said second segment of SM fibers of said segment-type fibers in a multi-layer stack.

19. The method of claim 15, wherein arranging said plurality of segment-type fibers comprises aligning fast and slow polarization directions of said first segment of PM fibers of said segment-type fibers in a same orientation.

20. The method of claim 15, wherein said first segment of PM fiber being spliced to said second segment of SM fiber at a connection point, wherein fusing and drawing said common section comprises making said connection point less than about 10 mm away from said fused optical coupling region.
